(19) United States
(12) Patent Application Publication
(10) Pub. No.: US 2006/0261509 A1
(43) Pub. Date: Nov. 23, 2006

(54) Method for making fiber reinforced polypropylene composites

(76) Inventors: Arnold Lustiger, Edison, NJ (US); Augie Machado, Raritan, NJ (US); Walter T. Matuszek, Easton, PA (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/318,363

(22) Filed: Dec. 23, 2005

Related U.S. Application Data
(60) Provisional application No. 60/681,609, filed on May 17, 2005.

(30) Foreign Application Priority Data
Dec. 13, 2005 (DE) 828083449

(51) Int. Cl. B29C 47/60; B29B 9/06; B29B 7/00; B29C 45/00

(52) U.S. Cl. 264/143; 264/328.18; 264/211; 264/211.23

(57) ABSTRACT

The present invention is directed generally to processes for making fiber reinforced polypropylene resins including at least 25 wt % polypropylene based polymer, from 5 to 60 wt % organic fiber, and from 0 to 60 wt % inorganic filler. The process includes extrusion compounding the polypropylene based polymer, the organic fiber, and the inorganic filler to form a fiber reinforced polypropylene resin, which is subsequently molded to form an article with a flexural modulus of at least 300,000 psi, that exhibits ductility during instrumented impact testing (15 mph, −29° C., 25 lbs). Twin screw extruder compounding processes where the organic fiber is continuously fed to the extruder hopper by unwinding from one or more spools, and uniformly dispersed in the fiber reinforced polypropylene resin by twin screws having a combination of conveying and kneading elements are also disclosed.

### CROSS-REFERENCE TO RELATED APPLICATION

This application is a Continuation-in-Part of U.S. Patent Application Express Mail No. ED 828083449 US filed Dec. 13, 2005, and claims priority of U.S. Provisional Application 60/681,609 filed May 17, 2005.

### FIELD OF THE INVENTION

The present invention is directed generally to articles made from fiber reinforced polypropylene compositions having a flexural modulus of at least 300,000 psi and exhibiting ductility during instrumented impact testing. The present invention is also directed to processes for making such articles. It more particularly relates to an advantageous method for making fiber reinforced polypropylene composites. Still more particularly, the present invention relates to a method of consistently feeding fiber into a twin screw compounding process, and uniformly and randomly dispersing the fiber in the polypropylene matrix.

### BACKGROUND OF THE INVENTION

Polyolefins have limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced which address toughness. For example, it is known to increase the toughness of polypropylene by adding rubber particles, either in-reactor resulting in impact copolymers, or through post-reactor blending. However, while toughness is improved, the stiffness is considerably reduced using this approach.

Glass reinforced polypropylene compositions have been introduced to improve stiffness. However, the glass fibers have a tendency to break in typical injection molding equipment, resulting in reduced toughness and stiffness. In addition, glass reinforced products have a tendency to warp after injection molding

Another known method of improving physical properties of polyolefins is organic fiber reinforcement. For example, EP Patent Application 0397881, the entire disclosure of which is hereby incorporated herein by reference, discloses a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the entire disclosure of which is hereby incorporated herein by reference, discloses a composition including a polymer, such as polypropylene, and uniformly dispersed therein at least about 10% by weight of the composition staple length fiber, the fiber being of man-made polymers, such as poly(ethylene terephthalate) or poly(1,4-cyclohexylenedimethylene terephthalate).

Fiber reinforced polypropylene compositions are also disclosed in PCT Publication WO02/053629, the entire disclosure of which is hereby incorporated herein by reference. More specifically, WO02/053629 discloses a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

Various modifications to organic fiber reinforced polypropylene compositions are also known. For example, polyolefins modified with maleic anhydride or acrylic acid have been used as the matrix component to improve the interface strength between the synthetic organic fiber and the polyolefin, which was thought to enhance the mechanical properties of the molded product made therefrom.

Other background references include PCT Publication WO90/05164; EP Patent Application 0669372; U.S. Pat. No. 6,395,342 to Kadowaki et al.; EP Patent Application 1075918; U.S. Pat. No. 5,145,891 to Yasukawa et al., U.S. Pat. No. 5,145,892 to Yasukawa et al.; and EP Patent 0232522, the entire disclosures of which are hereby incorporated herein by reference.

U.S. Pat. No. 3,304,282 to Cadus et al. discloses a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent discloses an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. discloses a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. discloses an impregnation process for preparing pellets of a synthetic organic fiber reinforced polyolefin. The process comprises the steps of heating a polyolefin at the temperature which is higher than the melting point thereof by 40 degree C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. discloses a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

Consistently feeding PET fibers into a compounding extruder is an issue encountered during the production of PP-PET fiber composites. Gravimetric or vibrational feeders are used in the metering and conveying of polymers, fillers and additives into the extrusion compounding process. These feeders are designed to convey materials at a constant rate using a single or twin screw by measuring the weight loss in the hopper of the feeder. These feeders are effective in conveying pellets or powder, but are not effective in conveying cut fiber. Cut fiber tends to bridge and entangle in these feeders resulting in an inconsistent feed rate to the compounding process. More particularly, at certain times, fiber gets hung up in the feeder and little is conveyed, while at other times, an overabundance of fiber is conveyed to the compounding extruder. FIG. 1 is an illustrative plot of the feed rate of ¼ inch chopped polyester fiber through a typical gravimetric feeder using the prior art method. The feed rate may vary anywhere from 3 to 18 grams per 5 seconds of feeding. This inconsistency is far from adequate to produce a fiber reinforced polypropylene in an extruder with a consistent percentage of fiber incorporated into the polypropylene based resin.

Another issue encountered during the production of PP-PET fiber composites is adequately dispersing the PET fibers into the PP matrix while still maintaining the advantageous mechanical properties imparted by the incorporation of the PET fibers. More particularly, extrusion compounding screw configuration may impact the dispersion of PET fibers within the PP matrix, and extrusion compounding processing conditions may impact not only the mechanical properties of the matrix polymer, but also the mechanical properties of the PET fibers.

A need exists of an improved method for making fiber reinforced polypropylene composites, and in particular, consistently feeding organic fiber into the polypropylene based resin during the compounding process. In addition, a need exists for an improved method for making fiber reinforced polypropylene composites, and in particular, compounding polypropylene based resin and organic fiber such that the composite resin includes a uniform distribution of cut fiber, which improves the impact resistance and flexural modulus of parts molded from the composite resin.

### SUMMARY OF THE INVENTION

It has surprisingly been found that substantially lubricant-free fiber reinforced polypropylene compositions can be made which simultaneously have a flexural modulus of at least 300,000 psi and exhibit ductility during instrumented impact testing. Particularly surprising is the ability to make such compositions using a wide range of polypropylenes as the matrix material, including some polypropylenes that without fiber are very brittle. The compositions of the present invention are particularly suitable for making articles including, but not limited to household appliances, automotive parts, and boat hulls. It has also been surprisingly found that organic fiber may be fed into a twin screw compounding extruder by continuously unwinding from one or more spools into the feed hopper of the twin screw extruder, and then chopped into ¼ inch to 1 inch lengths by the twin screws to form a fiber reinforced polypropylene based composite.

In one embodiment, the present invention provides an article of manufacture made from a composition comprising, based on the total weight of the composition, at least 30 wt % polypropylene, from 10 to 60 wt % organic fiber, from 0 to 40 wt % inorganic filler, and from 0 to 0.1 wt % lubricant. The composition has a flexural modulus of at least 300,000 psi and exhibits ductility during instrumented impact testing (15 mph, −29° C., 25 lbs). In another embodiment, the fiber reinforced polypropylene composite with an inorganic filler further includes from 0.01 to 0.1 wt % lubricant. Suitable lubricants include, but are not limited to, silicon oil, silicon gum, fatty amide, paraffin oil, paraffin wax, and ester oil. In another embodiment, the present invention provides an automotive part made from such composition.

In another embodiment, the present invention provides an article of manufacture made from a composition consisting essentially of at least 30 wt % homopolypropylene, from 10 to 60 wt % organic fiber, and from 0.1 to 40 wt % inorganic filler, based on the total weight of the composition. The composition has a flexural modulus of at least 300,000 psi and exhibits ductility during instrumented impact testing (15 mph, −25° C., 25 lbs).

In yet another embodiment, the present invention provides a process for making an automotive part. The process comprises extrusion compounding a composition to form an extrudate and injection molding the extrudate to form the automotive part. The composition used to form the extrudate comprises at least 30 wt % polypropylene, from 10 to 60 wt % organic fiber, from 0 to 40 wt % inorganic filler, and from 0 to 0.1 wt % lubricant. The composition has a flexural modulus of at least 300,000 psi and exhibits ductility during instrumented impact testing (15 mph, −29° C., 25 lbs).

In yet another embodiment of the present disclosure provides an advantageous process for making an article comprising at least 30 wt %, based on the total weight of the composition, polypropylene; from 10 to 60 wt %, based on the total weight of the composition, organic fiber; from 0 to 40 wt %, based on the total weight of the composition, inorganic filler; and from 0 to 0.1 wt %, based on the total weight of the composition, lubricant; wherein the composition has a flexural modulus of at least 400,000 psi, and exhibits ductility during instrumented impact testing, and wherein the process comprises the steps of extrusion compounding the composition to form an extrudate; and injection molding the extrudate to form the article.

In still yet another embodiment of the present disclosure provides an advantageous process for making fiber reinforced polypropylene composite pellets comprising the steps of feeding into a twin screw extruder hopper at least about 25 wt % of a polypropylene based resin with a melt flow rate of from about 20 to about 1500 g/10 minutes, continuously feeding by unwinding from one or more spools into said twin screw extruder hopper from about 5 wt % to about 40 wt % of an organic fiber, feeding into a twin screw extruder from about 10 wt % to about 60 wt % of an inorganic filler, extruding said polypropylene based resin, said organic fiber, and said inorganic filler through said twin screw extruder to form a fiber reinforced polypropylene composite melt, cooling said fiber reinforced polypropylene composite melt to form a solid fiber reinforced polypropylene composite, and pelletizing said solid fiber reinforced polypropylene composite to form a fiber reinforced polypropylene composite resin.

Numerous advantages result from the advantageous polypropylene fiber composites, method of making disclosed herein and the uses/applications therefore.

For example, in exemplary embodiments of the present disclosure, the disclosed polypropylene fiber composites exhibit improved instrumented impact resistance.

In a further exemplary embodiment of the present disclosure, the disclosed polypropylene fiber composites exhibit improved flexural modulus.

In a further exemplary embodiment of the present disclosure, the disclosed polypropylene fiber composites do not splinter during instrumented impact testing.

In yet a further exemplary embodiment of the present disclosure, the disclosed polypropylene fiber composites exhibit fiber pull out during instrumented impact testing without the need for lubricant additives.

In yet a further exemplary embodiment of the present disclosure, the disclosed polypropylene fiber composites exhibit a higher heat distortion temperature compared to rubber toughened polypropylene.

In yet a further exemplary embodiment of the present disclosure, the disclosed polypropylene fiber composites exhibit a lower flow and cross flow coefficient of linear thermal expansion compared to rubber toughened polypropylene.

In another exemplary embodiment of the present disclosure, the disclosed process for making fiber reinforced polypropylene composite pellets exhibits the ability to continuously and accurately feed organic fiber into a twin screw compounding extruder.

In another exemplary embodiment of the present disclosure, the disclosed process for making fiber reinforced polypropylene composite pellets exhibits uniform dispersion of the organic fiber in the pellets.

In another exemplary embodiment of the present disclosure, the disclosed process for making fiber reinforced polypropylene composite pellets exhibits the beneficial mechanical properties imparted by the organic fiber in the pellets.

These and other advantages, features and attributes of the disclosed polypropylene fiber composites, and method of making of the present disclosure and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 depicts the feed rate through a gravimetric feeder for chopped ¼ inch PET fiber (prior art method).

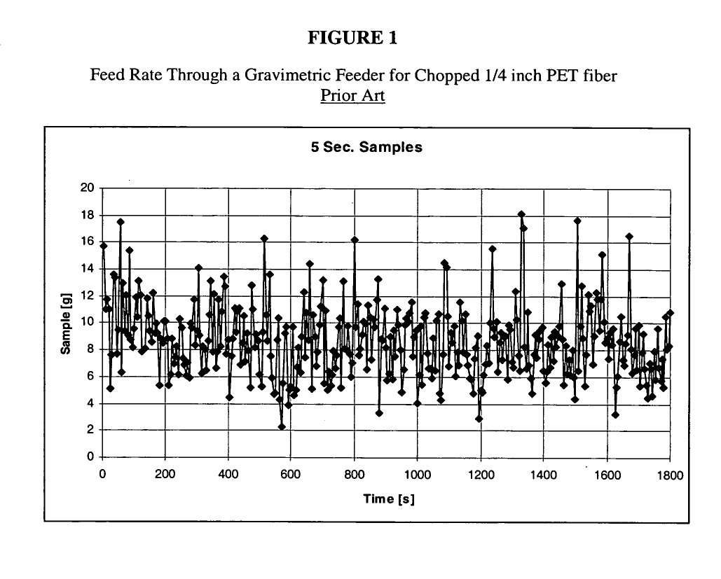

FIG. 2 depicts an exemplary schematic of the process for making fiber reinforced polypropylene composites of the instant invention.

FIG. 3 depicts an exemplary schematic of a twin screw extruder with a downstream feed port for making fiber reinforced polypropylene composites of the instant invention.

FIG. 4 depicts an exemplary schematic of a twin screw extruder screw configuration for making fiber reinforced polypropylene composites of the instant invention.

### DETAILED DESCRIPTION OF THE INVENTION

The present invention relates to improved fiber reinforced polypropylene compositions and method of making therein for use in molding applications. The fiber reinforced polypropylene compositions of the present invention are distinguishable over the prior art in comprising a combination of a polypropylene based matrix with organic fiber and inorganic filler, which in combination advantageously yield articles molded from the compositions with a flexural modulus of at least 300,000 psi and ductility during instrumented impact testing (15 mph, −29° C., 25 lbs). The fiber reinforced polypropylene compositions of the present invention are also distinguishable over the prior art in comprising a polypropylene based matrix polymer with an advantageous high melt flow rate without sacrificing impact resistance. In addition, fiber reinforced polypropylene compositions of the present invention do not splinter during instrumented impact testing. The process of making fiber reinforced polypropylene compositions of the present invention are distinguishable over the prior art in continuously feeding organic fiber into the feed hopper of the twin screw extruder.

The fiber reinforced polypropylene compositions of the present invention simultaneously have desirable stiffness, as measured by having a flexural modulus of at least 300,000 psi, and toughness, as measured by exhibiting ductility during instrumented impact testing. In a particular embodiment, the compositions have a flexural modulus of at least 350,000 psi, or at least 370,000 psi, or at least 390,000 psi, or at least 400,000 psi, or at least 450,000 psi. Still more particularly, the compositions have a flexural modulus of at least 600,000 psi, or at least 800,000 psi. It is also believed that having a weak interface between the polypropylene matrix and the fiber contributes to fiber pullout; and, therefore, may enhance toughness. Thus, there is no need to add modified polypropylenes to enhance bonding between the fiber and the polypropylene matrix, although the use of modified polypropylene may be advantageous to enhance the bonding between a filler, such as talc or wollastonite and the matrix. In addition, in one embodiment, there is no need to add lubricant to weaken the interface between the polypropylene and the fiber to further enhance fiber pullout. Some embodiments also display no splintering during instrumented dart impact testing, which yield a further advantage of not subjecting a person in close proximity to the impact to potentially harmful splintered fragments.

Compositions of the present invention generally include at least 30 wt %, based on the total weight of the composition, of polypropylene as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 75 wt %, or 80 wt %, based on the total weight of the composition. In another embodiment, the polypropylene is present in an amount of at least 25 wt %.

The polypropylene used as the matrix resin is not particularly restricted and is generally selected from the group consisting of propylene homopolymers, propylene-ethylene random copolymers, propylene-α-olefin random copolymers, propylene block copolymers, propylene impact copolymers, and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene of the matrix resin may have a melt flow rate of from about 20 to about 1500 g/10 min. In a particular embodiment, the melt flow rate of the polypropylene matrix resin is greater 100 g/10 min, and still more particularly greater than or equal to 400 g/10 min. In yet another embodiment, the melt flow rate of the polypropylene matrix resin is about 1500 g/10 min. The higher melt flow rate permits for improvements in processability, throughput rates, and higher loading levels of organic fiber and inorganic filler without negatively impacting flexural modulus and impact resistance.

In a particular embodiment, the matrix polypropylene contains less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from about 0.1 wt % to less than about 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polypropylene matrix is generally from 0.5 wt %, or 2.5 wt %, to 7.5 wt %, or 10 wt %, based on the total weight of the matrix. Diffusion of additive(s) during processing may cause a portion of the additive(s) to be present in the fiber.

The invention is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the invention is not limited to any particular catalyst for making the polypropylene, and may, for example, include Ziegler-Natta or metallocene catalysts.

Compositions of the present invention generally include at least 10 wt %, based on the total weight of the composition, of an organic fiber. In a particular embodiment, the fiber is present in an amount of at least 10 wt %, or at least 15 wt %, or at least 20 wt %, or in an amount within the range having a lower limit of 10 wt %, or 15 wt %, or 20 wt %, and an upper limit of 50 wt %, or 55 wt %, or 60 wt %, or 70 wt %, based on the total weight of the composition. In another embodiment, the organic fiber is present in an amount of at least 5 wt % and up to 40 wt %.

The polymer used as the fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another particular embodiment, the organic fiber comprises PET.

In one embodiment, the fiber is a single component fiber. In another embodiment, the fiber is a multicomponent fiber wherein the fiber is formed from a process wherein at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the fibers of the present invention are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the fibers is within the range having a lower limit of 10 μm and an upper limit of 100 μm.

The fiber may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment.

The fiber used to make the compositions of the present invention is not limited by any particular fiber form. For example, the fiber can be in the form of continuous filament yarn, partially oriented yarn, or staple fiber. In another embodiment, the fiber may be a continuous multifilament fiber or a continuous monofilament fiber.

Compositions of the present invention optionally include inorganic filler in an amount of at least 1 wt %, or at least 5 wt %, or at least 10 wt %, or in an amount within the range having a lower limit of 0 wt %, or 1 wt %, or 5 wt %, or 10 wt %, or 15 wt %, and an upper limit of 25 wt %, or 30 wt %, or 35 wt %, or 40 wt %, based on the total weight of the composition. In yet another embodiment, the inorganic filler may be included in the polypropylene fiber composite in the range of from 10 wt % to about 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof. The talc may have a size of from about 1 to about 100 microns. In one particular embodiment, at a high talc loading of up to about 60 wt %, the polypropylene fiber composite exhibited a flexural modulus of at least about 750,000 psi and no splintering during instrumented impact testing (15 mph, −29° C., 25 lbs). In another particular embodiment, at a low talc loading of as low as 10 wt %, the polypropylene fiber composite exhibited a flexural modulus of at least about 325,000 psi and no splintering during instrumented impact testing (15 mph, −29° C., 25 lbs). In addition, wollastonite loadings of from 10 wt % to 60 wt % in the polypropylene fiber composite yielded an outstanding combination of impact resistance and stiffness.

In another particular embodiment, a fiber reinforced polypropylene composition including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of 140 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively

Articles of the present invention are made by forming the fiber-reinforced polypropylene composition and then injection molding the composition to form the article. The invention is not limited by any particular method for forming the compositions. For example, the compositions can be formed by contacting polypropylene, organic fiber, and optional inorganic filler in any of the well known processes of pultrusion or extrusion compounding. In a particular embodiment, the compositions are formed in an extrusion compounding process. In a particular aspect of this embodiment, the organic fibers are cut prior to being placed in the extruder hopper. In another particular aspect of this embodiment, the organic fibers are fed directly from one or more spools into the extruder hopper. Articles made from the compositions described herein include, but are not limited to automotive parts, household appliances, and boat hulls.

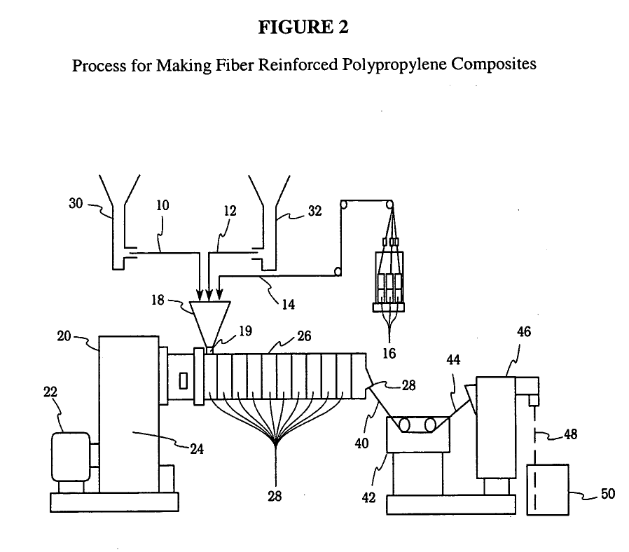

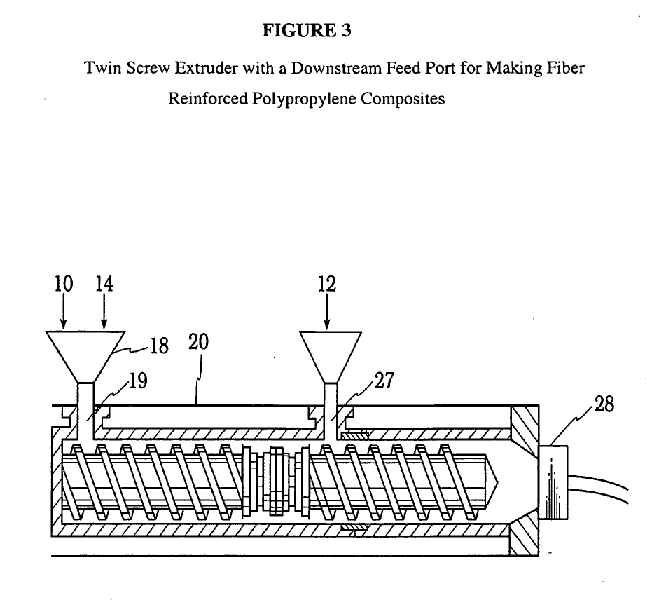

FIG. 2 depicts an exemplary schematic of the process for making fiber reinforced polypropylene composites of the instant invention. Polypropylene based resin 10, inorganic filler 12, and organic fiber 14 continuously unwound from one or more spools 16 are fed into the extruder hopper 18 of a twin screw compounding extruder 20. The extruder hopper 18 is positioned above the feed throat 19 of the twin screw compounding extruder 20. The extruder hopper 18 may alternatively be provided with an auger (not shown) for mixing the polypropylene based resin 10 and the inorganic filler 12 prior to entering the feed throat 19 of the twin screw compounding extruder 20. In an alternative embodiment, as depicted in FIG. 3, the inorganic filler 12 may be fed to the twin screw compounding extruder 20 at a downstream feed port 27 in the extruder barrel 26 positioned downstream of the extruder hopper 18 while the polypropylene based resin 10 and the organic fiber 14 are still metered into the extruder hopper 18.

The polypropylene based resin 10 is metered to the extruder hopper 18 via a feed system 30 for accurately controlling the feed rate. Similarly, the inorganic filler 12 is metered to the extruder hopper 18 via a feed system 32 for accurately controlling the feed rate. The feed systems 30, 32 may be, but are not limited to, gravimetric feed system or volumetric feed systems. Gravimetric feed systems are particularly preferred for accurately controlling the weight percentage of polypropylene based resin 10 and inorganic filler 12 being fed to the extruder hopper 18. The feed rate of organic fiber 14 to the extruder hopper 18 is controlled by a combination of the extruder screw speed, number of fiber filaments and the thickness of each filament in a given fiber spool, and the number of fiber spools 16 being unwound simultaneously to the extruder hopper 18. The higher the extruder screw speed measured in revolutions per minute (rpms), the greater will be the rate at which organic fiber 14 is fed to the twin screw compounding screw 20. The rate at which organic fiber 14 is fed to the extruder hopper also increases with the greater the number of filaments within the organic fiber 14 being unwound from a single fiber spool 16, the greater filament thickness, the greater the number fiber spools 16 being unwound simultaneously, and the rotations per minute of the extruder.

The twin screw compounding extruder 20 includes a drive motor 22, a gear box 24, an extruder barrel 26 for holding two screws (not shown), and a strand die 28. The extruder barrel 26 is segmented into a number of heated temperature controlled zones 28. As depicted in FIG. 2, the extruder barrel 26 includes a total of ten temperature control zones 28. The two screws within the extruder barrel 26 of the twin screw compounding extruder 20 may be intermeshing or non-intermeshing, and may rotate in the same direction (co-rotating) or rotate in opposite directions (counter-rotating). From a processing perspective, the melt temperature must be maintained above that of the polypropylene based resin 10, and far below the melting temperature of the organic fiber 14, such that the mechanical properties imparted by the organic fiber will be maintained when mixed into the polypropylene based resin 10. In one exemplary embodiment, the barrel temperature of the extruder zones did not exceed 154° C. when extruding PP homopolymer and PET fiber, which yielded a melt temperature above the melting point of the PP homopolymer, but far below the melting point of the PET fiber. In another exemplary embodiment, the barrel temperatures of the extruder zones are set at 185° C. or lower.

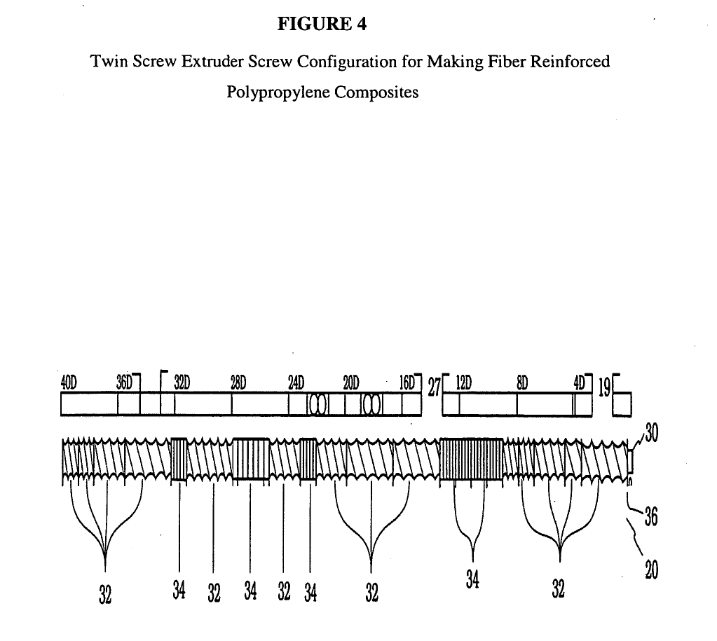

An exemplary schematic of a twin screw compounding extruder 20 screw configuration for making fiber reinforced polypropylene composites is depicted in FIG. 4. The feed throat 19 allows for the introduction of polypropylene based resin, organic fiber, and inorganic filler into a feed zone of the twin screw compounding extruder 20. The inorganic filler may be optionally fed to the extruder 20 at the downstream feed port 27. The twin screws 30 include an arrangement of interconnected screw sections, including conveying elements 32 and kneading elements 34. The kneading elements 34 function to melt the polypropylene based resin, cut the organic fiber lengthwise, and mix the polypropylene based melt, chopped organic fiber and inorganic filler to form a uniform blend. More particularly, the kneading elements function to break up the organic fiber into about ⅛ inch to about 1 inch fiber lengths. A series of interconnected kneading elements 34 is also referred to as a kneading block. U.S. Pat. No. 4,824,256 to Haring, et al., herein incorporated by reference in its entirety, discloses co-rotating twin screw extruders with kneading elements. The first section of kneading elements 34 located downstream from the feed throat is also referred to as the melting zone of the twin screw compounding extruder 20. The conveying elements 32 function to convey the solid components, melt the polypropylene based resin, and convey the melt mixture of polypropylene based polymer, inorganic filler and organic fiber downstream toward the strand die 28 (see FIG. 2) at a positive pressure.

The position of each of the screw sections as expressed in the number of diameters (D) from the start 36 of the extruder screws 30 is also depicted in FIG. 4. The extruder screws in FIG. 4 have a length to diameter ratio of 40/1, and at a position 32D from the start 36 of screws 30, there is positioned a kneading element 34. The particular arrangement of kneading and conveying sections is not limited to that as depicted in FIG. 4, however one or more kneading blocks consisting of an arrangement of interconnected kneading elements 34 may be positioned in the twin screws 30 at a point downstream of where organic fiber and inorganic filler are introduced to the extruder barrel. The twin screws 30 may be of equal screw length or unequal screw length. Other types of mixing sections may also be included in the twin screws 30, including, but not limited to, Maddock mixers, and pin mixers.

Referring once again to FIG. 2, the uniformly mixed fiber reinforced polypropylene composite melt comprising polypropylene based polymer 10, inorganic filler 12, and organic fiber 14 is metered by the extruder screws to a strand die 28 for forming one or more continuous strands 40 of fiber reinforced polypropylene composite melt. The one or more continuous strands 40 are then passed into water bath 42 for cooling them below the melting point of the fiber reinforced polypropylene composite melt to form a solid fiber reinforced polypropylene composite strands 44. The water bath 42 is typically cooled and controlled to a constant temperature much below the melting point of the polypropylene based polymer. The solid fiber reinforced polypropylene composite strands 44 are then passed into a pelletizer or pelletizing unit 46 to cut them into fiber reinforced polypropylene composite resin 48 measuring from about ¼ inch to about 1 inch in length. The fiber reinforced polypropylene composite resin 48 may then be accumulated in boxes 50, barrels, or alternatively conveyed to silos for storage.

The present invention is further illustrated by means of the following examples, and the advantages thereto without limiting the scope thereof.

Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., 25 lbs) is defined as no splintering of the sample.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

Cimpact CB7 is a surface modified talc, V3837 is a high aspect ratio talc, and Jetfine 700 C is a high surface area talc, all available from Luzenac America Inc. of Englewood, Colo.

### Illustrative Examples 1-8

Varying amounts of PP3505G and 0.25″ long polyester fibers obtained from Invista Corporation were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | wt % | wt % | Total Energy | Instrumented |
|---|---|---|---|---|
| Example # | PP3505G | Fiber | (ft-lbf) | Impact Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | Brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 25″ long polyester fibers obtained from Invista Corporation, were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| | Impact Conditions/Applied | Energy | Impact Test |
| Example # | Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit to form a kneading block. The die was ¼″ in diameter. Strands of continuous 27,300 denier PET fibers were fed directly from spools into the hopper of the extruder, along with PP7805 and talc. The kneading elements in the kneading block in the extruder broke up the fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | |
|---|---|---|
| Test | PET fiber-reinforced | Example 16 |
| (Method) | PP7805 with talc | PP8224 |
| Flexural Modulus, Chord | 525,190 psi | 159,645 psi |
| (ISO 178) | | |
| Instrumented Impact at −30° C. | 6.8 J | 27.5 J |
| Energy to maximum load | | |
| 100 lbs at 5 MPH | | |
| (ASTM D3763) | | |
| Notched Charpy Impact at −40° C. | 52.4 kJ/m² | 5.0 kJ/m² |
| (ISO 179/1 eA) | | |
| Heat Deflection Temperature | 116.5° C. | 97.6° C. |
| at 0.45 Mpa, edgewise | | |
| (ISO 75) | | |
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTM E831) | | |

### Illustrative Examples 17-18

In Examples 17-18, 30 wt % of either PP3505G or PP8224, 15 wt % 0.25″ long polyester fibers obtained from Invista Corporation, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | | Instrumented Impact |
|---|---|---|---|
| | | | at −30° C. |
| | | | Energy to maximum |
| | | Flexural Modulus, | load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ long polyester fibers obtained from Invista Corporation, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressure were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

It is important to note that in examples 19-24, the samples displayed no splintering in drop weight testing at an −29° C., 15 miles per hour at 25 pounds.

### Illustrative Examples 25-26

Two materials, one containing 10% ¼ inch polyester fibers, 35% PP3505 polypropylene and 60% V3837 talc (example 25), the other containing 10% ¼ inch polyester fibers, 25% PP3505 polypropylene homopolymer (example 26), 10% PO1020 modified polypropylene were molded in a Haake twin screw extruder at 175° C. They were injection molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| Percentage of | | |
|---|---|---|
| Maximum Stress to | Example 25, | Example 26, |
| Yield Point | Cycles to failure | Cycles to failure |
| 70 | 327 | 9848 |
| 80 | 30 | 63 |

The addition of the modified polypropylene is shown to increase the fatigue life of these materials.

### Illustrative Examples 27-29

A Leistritz 27 mm co-rotating twin screw extruder with a ratio of length to diameter of 40:1 was used in these experiments. The process configuration utilized was as depicted in FIG. 2. The screw configuration used is depicted in FIG. 4, and includes an arrangement of conveying and kneading elements. Talc, polypropylene and PET fiber were all fed into the extruder feed hopper located approximately two diameters from the beginning of the extruder screws (19 in the FIG. 4). The PET fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin produced was injection molded and displayed the following properties:

TABLE 7

| | Example 27 |
|---|---|
| Specific Gravity | 1.3 |
| Tensile Modulus, Chord @ 23° C. | 541865 psi |
| Tensile Modulus, Chord @ 85° C. | 257810 psi |
| Flexural Modulus, Chord @ 23° C. | 505035 psi |
| Flexural Modulus, Chord @ 85° C. | 228375 psi |
| HDT @ 0.45 MPA | 116.1° C. |
| HDT @ 1.80 MPA | 76.6° C. |
| Instrumented impact @ 23° C. | 11.8 J D** |
| Instrumented impact @ −30° C. | 12.9 J D** |

**Ductile failure with radial cracks

In example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET fiber were negatively impacted during extrusion compounding such that the PET/PP composite resin had poor instrumented impact test properties.

In example 29, the fiber was fed into a hopper placed 14 diameters down the extruder (27 in the FIG. 4). In this case, the extrudate produced was irregular in diameter and broke an average once every minute as it was pulled through the quenching water bath. When the PET fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester fiber.

The PP composite resin produced while all temperature zones of the extruder were set to 120° C. was injection molded and displayed the following properties:

TABLE 8

| | Example 30 |
|---|---|
| Flexural Modulus, Chord @ 23° C. | 467,932 psi |
| Instrumented impact @ 23° C. | 8.0 J D** |
| Instrumented impact @ −30° C. | 10.4 J D** |

**Ductile failure with radial cracks

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

When numerical lower limits and numerical upper limits are listed herein, ranges from any lower limit to any upper limit are contemplated.

What is claimed is:

1. A process for making an automotive part, the process comprising:
(a) extrusion compounding a composition to form an extrudate, wherein the composition comprises at least 30 wt % polypropylene, from 10 to 60 wt % organic fiber, from 0 to 40 wt % inorganic filler, and from 0 to 0.1 wt % lubricant, based on the total weight of the composition, and wherein the composition has a flexural modulus of at least 300,000 psi and exhibits ductility during instrumented impact testing; and
(b) injection molding the extrudate to form the automotive part.

2. The process of claim 1, wherein the organic fiber is cut prior to the extrusion compounding step.

3. The process of claim 1, wherein during the extrusion compounding step, the organic fiber is a continuous fiber and is fed directly from one or more spools into an extruder hopper.

4. An automotive part made by the process of claim 1.

5. The automotive part of claim 4, wherein the automotive part is an automobile bumper.

6. A process for making an article comprising:
(a) at least 30 wt %, based on the total weight of the composition, polypropylene;
(b) from 10 to 60 wt %, based on the total weight of the composition, organic fiber;
(c) from 0 to 40 wt %, based on the total weight of the composition, inorganic filler; and
(d) from 0 to 0.1 wt %, based on the total weight of the composition, lubricant;
wherein the composition has a flexural modulus of at least 400,000 psi, and exhibits ductility during instrumented impact testing,
wherein the process comprises the steps of:
(a) extrusion compounding the composition to form an extrudate; and
(b) injection molding the extrudate to form the article.

7. The process of claim 6, wherein the organic fiber is cut prior to the extrusion compounding step.

8. The process of claim 6, wherein during the extrusion compounding step, the organic fiber is a continuous fiber and is fed directly from one or more spools into an extruder hopper.

9. An automotive part made by the process of claim 8.

10. The automotive part of claim 9, wherein the automotive part is an automobile bumper.

11. A process for making fiber reinforced polypropylene composite pellets comprising the following steps:
(a) feeding into a twin screw extruder hopper at least about 25 wt % of a polypropylene based resin with a melt flow rate of from about 20 to about 1500 g/10 minutes,
(b) continuously feeding by unwinding from one or more spools into said twin screw extruder hopper from about 5 wt % to about 40 wt % of an organic fiber,
(c) feeding into a twin screw extruder from about 10 wt % to about 60 wt % of an inorganic filler,
(d) extruding said polypropylene based resin, said organic fiber, and said inorganic filler through said twin screw extruder to form a fiber reinforced polypropylene composite melt,
(e) cooling said fiber reinforced polypropylene composite melt to form a solid fiber reinforced polypropylene composite, and
(f) pelletizing said solid fiber reinforced polypropylene composite to form a fiber reinforced polypropylene composite resin.

12. The process of claim 11 wherein an article molded from said fiber reinforced composite resin has a flexural modulus of at least about 300,000 psi and exhibits ductility during instrumented impact testing.

13. The process of claim 11 wherein said polypropylene based resin is selected from the group consisting of polypropylene homopolymers, propylene-ethylene random copolymers, propylene-α-olefin random copolymers, propylene impact copolymers, and combinations thereof.

14. The process of claim 13 wherein said polypropylene based resin is polypropylene homopolymer with a melt flow rate of from about 150 to about 1500 g/10 minutes.

15. The process of claim 11 wherein said polypropylene based resin further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

16. The process of claim of claim 11 further comprising the step of feeding from about 0.01 to about 0.1 wt % lubricant, based on the total weight of the fiber reinforced polypropylene composite pellets, wherein said lubricant is selected from the group consisting of silicon oil, silicon gum, fatty amide, paraffin oil, paraffin wax, and ester oil.

17. The process of claim 11 wherein said organic fiber is selected from the group consisting of polyalkylene terephthalates, polyalkylene naphthalates, polyamides, polyolefins, polyacrylonitrile, and combinations thereof.

18. The process of claim 17 wherein said organic fiber is polyethylene terephthalate.

19. The process of claim 11 wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

20. The process of claim 19 wherein said inorganic filler is talc or wollastonite.

21. The process of claim 11 wherein said step of feeding a polypropylene based resin into said twin screw extruder hopper is with the use of a gravimetric feed system.

22. The process of claim 11 wherein said step of feeding an inorganic filler into said twin screw extruder further comprises feeding said inorganic filler into said twin screw extruder hopper via a gravimetric feed system or feeding said inorganic filler into said twin screw extruder at a downstream injection port via a gravimetric feed system.

23. The process of claim 11 wherein said twin screw extruder comprises two extruder screws configured with interconnected screw elements to have a feed zone, a melting zone, one or more mixing sections, one or more decompression sections and one or more conveying sections.

24. The process of claim 23 wherein said two extruder screws are of a co-rotating intermeshing, counter-rotating intermeshing, or counter-rotating non-intermeshing screw type.

25. The process of claim 23 wherein said one or more mixing sections comprise one or more kneading blocks positioned along the length of said two extruder screws.

26. The process of claim 25 wherein said one or more kneading blocks comprise a series of interconnected kneading elements.

27. The process of claim 25 wherein said one or more mixing sections break up said organic fiber into about ⅛ inch to about 1 inch fiber lengths.

28. The process of claim 11 wherein said step of cooling said fiber reinforced polypropylene composite melt to form a solid fiber reinforced polypropylene composite is by continuously passing strands of said fiber reinforced polypropylene composite melt through a cooled water bath.

29. The process of claim 11 wherein said step of pelletizing said solid fiber reinforced polypropylene composite to form a fiber reinforced polypropylene composite resin is by continuously passing said solid fiber reinforced polypropylene composite through a pelletizing unit.

30. The process of claim 29 wherein said fiber reinforced polypropylene composite resin comprises pellets of from about ¼ inch to about 1 inch in length.

31. The process of claim 11 wherein said twin screw extruder comprises barrel temperature control zone set points of less than or equal to 185° C.

32. The process of claim 31 wherein said twin screw extruder comprises barrel temperature control zone set points of less than or equal to 165° C.

33. The process of claim 32 wherein an article molded from said fiber reinforced composite resin has a flexural modulus of at least about 300,000 psi and exhibits ductility during instrumented impact testing

34. The process of claim 28 wherein said fiber reinforced polypropylene composite melt does not break when conveyed through said cooled water bath.
